(19) United States
(12) Patent Application Publication
(10) Pub. No.: US 2022/0192207 A1
(43) Pub. Date: Jun. 23, 2022

(54) SHELF-STABLE CAKE TRUFFLE

(71) Applicant: The Hershey Company, Hershey, PA (US)

(72) Inventors: Dongming Tang, Hummelstown, PA (US); Xiaoying Wang, Hummelstown, PA (US); Julia J. Watterson, Camp Hill, PA (US); Susan M. Benjamin, Harrisburg, PA (US); Robert J. Peles, Harrisburg, PA (US)

(73) Assignee: The Hershey Company, Hershey, PA (US)

(21) Appl. No.: 17/604,259

(22) PCT Filed: Apr. 15, 2020
(86) PCT No.: PCT/US2020/028190

§ 371 Date: Oct. 15, 2021

Related U.S. Application Data
(60) Provisional application No. 62/833,880, filed on Apr. 15, 2019.

(51) Int. Cl. A21D 13/24; A21D 13/28; A21D 13/80; A21D 2/18; A23G 3/40; A23G 3/54; A23G 3/42; A23G 1/30; A23G 3/34

(52) U.S. Cl. CPC A21D 13/24; A21D 13/28; A21D 13/80; A21D 2/186; A23V 2002/00; A23G 3/54; A23G 3/42; A23G 1/305; A23G 3/0065; A23G 3/40

(57) ABSTRACT

A modified cake formula and baking process to have a shelf-stable food product, especially micro-safe cake with water activity (Aw) less than about 0.71, less than about 0.7 or ideally less than about 0.65. The process involves grinding the baked cake fine crumbs, and blending the resulting crumbs with a binding agent to make a cake truffle, wherein the cake truffle has a water into activity less than around 0.7, and optionally covering the cake truffle with a confectionary coating, or with milk chocolate.

### CROSS-REFERENCE TO RELATED APPLICATIONS

This application claims the benefit of priority to U.S. Provisional Patent Application No. 62/833,880 filed on Apr. 15, 2019.

### TECHNICAL FIELD

This application is directed to confectionary food products, and methods of making the food products.

### BACKGROUND

Cake is a well known dessert or snack for many people. Cakes are found in many different forms, such as sheet cakes, layered or tiered cakes (having various shapes), shaped or molded cakes, and cupcakes. There are several commercial products having a texture similar to a cake pop.

A new trend has developed using freshly baked or recently baked cake to form a confectionary product. The cake is crumbled to form crumbs that are mixed with frosting and formed into a molded product. Typically, the product is formed into a single-serving ball, often approximately 1 to 2 inches in diameter, sometimes mounted on a stick. The product may also be formed as a bar or rectangular shape. Often, a confectionary coating, or a sweet edible layer, such as chocolate, is provided over the ball. This cake product is often referred to as a “cake bite”, “cake ball”, “cake pop” or “cake truffle”.

Current commercial cake pop and truffle products have a short shelf life. In some circumstances the shelf life is as short as a few days to a few weeks due to both texture deterioration and micro growth, especially yeast and mold growth. Sometimes these products can mold in less than 7 days if stored at an ambient condition (75 degrees F., 24 degrees Celsius, 50% RH).

U.S. Pat. No. 10,143,207 describes a method of achieving extended shelf life of the confectionary food products by means of product design. The '207 patent states that “although the total moisture content of the core remains essentially constant from the time of preparation until the end of the product's shelf life, a substantial re-distribution of moisture occurs within the core after preparation. Freshly prepared products have a core having a heterogeneous distribution of moisture; with the dehydrated crumbs having very low moisture and the shortening-based matrix having intermediate moisture levels.”

Ijabadeniyi and Pillay “Microbial Safety of Low Water Activity Foods: Study of Simulated and Durban Household Samples” 2017 (Journal of Food Quality, 2017, article ID 4931521, doi.org/10.1155/2017/4931521) has been stated to teach that a lower water activity and lower moisture content helps to prevent microbial growth. Specifically, foods with a water activity of no more than 0.6 do not allow for the growth of microorganisms.

### SUMMARY

The present disclosure extends shelf life by providing a shelf-stable confectionary food product. The product includes a modified cake formula and baking process to have a shelf-stable, especially micro-safe cake with water activity (Aw) less than about 0.71, less than about 0.7 or ideally less than about 0.65. For purposes of this disclosure, water activity, or A_{w}, refers to the ratio between vapor pressure of the food itself and the vapor pressure of distilled water under identical conditions.

In an embodiment of the cake formula, glycerine (in an amount of from about 1% to 10% of the cake, more specifically about 3.5%), mono- and di-saccharide sugar, modified starch, and micro crystalline cellulose are used to reduce the water activity and help to maintain the moistness of the cake. The ratio of mono- and di-saccharide sugar is typically from about 8:1 to about 1:1, in some embodiments from about 3:1 to about 2:1. In one embodiment, the modified starch may be a modified wheat starch such as Fibersym®, a phosphated distarch phosphate wheat starch, or a modified rice starch, such as RemyGel® 663, a fine cross-linked acetylated distarch phosphate, a modified potato starch, a modified tapioca starch or other similar modified starches or other similar hydrocolloids, such as polysaccharides or proteins to increase viscosity of the dough and retain moisture of the final product. In another embodiment, the starch is a native corn starch. It is envisioned that the ratio of mono- and di-saccharide sugar, the use of modified starch, and the binding agent reduce the water activity and help to maintain the moistness of the cake as well as provide a more desirable texture than commercial products.

The shelf-stable, confectionary food product comprises a core formed from baked cake crumbs and a binding agent; an optional crème layer, which substantially covers the top layer of the core; and an optional outer shell surrounding the core and/or the optional crème layer. The outer shell is a fat-based confectionary coating.

In one embodiment, the shelf-stable cake truffle product may have three layers: a bottom cake truffle layer, a crème layer (either oil-based or water-based) on the cake truffle layer, and a milk chocolate or a confectionery coating layer, which is generally fat-based. Each of the core or cake truffle layer, the crème layer and the outer shell may be single or multiple layers.

The baking process includes sheeting cake batter to about 7 mm to about 14 mm sheet and baking for about 21 to about 22 minutes. The resulting baked cake has water activity of about 0.65 to about 0.71.

The baked cake is then ground into fine crumbs and blended with a binding agent such as a syrup, fat-based crème or frosting to make a cake truffle. The water activity of the cake truffle is less than about 0.7 or ideally less than about 0.65. The cake truffle can be sheeted and covered with a crème layer. The crème layer may be a water- or oil-based filling or crème, such as a peanut butter layer, on top of the cake truffle layer may be added. An outer shell layer, such as in Reese's® milk chocolate, may be used to cover both the cake truffle and crème layer at a thickness of about 1 to about 3 mm. The outer shell preferably completely encompasses the core and the crème, providing a low-permeability coating about the core. Typically, the outer shell is no thicker than 5 mm.

The cake truffle has a distinguished moist texture according to sensory analysis. The covered cake truffle product with the peanut butter layer as an oil-based crème on top has a more desirable texture than commercial benchmark products.

In one aspect, this disclosure provides a shelf-stable, confectionary food product comprising a core formed from baked cake crumbs having water activity less than about 0.71 and a binding agent, a crème layer, wherein the top layer of the core is substantially covered with the crème, and an outer shell surrounding the core and crème, wherein the outer shell is milk chocolate. Each of the core or cake truffle layer, the crème layer and the outer shell may be single or multiple layers

In one aspect, this disclosure includes wherein the baked cake crumbs have water activity less than 0.7, optionally 0.65.

In one aspect, this disclosure includes the crème layer being a water- or oil-based filling, crème or frosting.

In one aspect, this disclosure includes the binding agent being syrup, fat-based crème or frosting.

In one aspect, this disclosure includes an outer shell which may be a fat-based confectionery coating including, but not limited to milk chocolate, white chocolate, and dark chocolate or other similar chocolates or other fat-based coatings.

Such a food product has a shelf life at room temperature of more than 1 month, more than 3 months, more than 6 months, or up to 9 months. For up to 9 months, the shelf-stable food products of this disclosure do not suffer from greater than 10 CFU/g microbial growth in spite of having a water activity at or slightly above 0.6.

In yet another aspect, this disclosure provides a method of making a shelf-stable food product by forming a cake truffle by sheeting a cake batter to about 7 mm to about 13 mm sheet and baking at about 325° F. for about 21 minutes to about 22 minutes with venting after 10 minutes of baking, wherein the resulting baked cake has a water activity within a range of about 0.65 to about 0.71, grinding the baked cake into fine crumbs, and blending the resulting crumbs with a binding agent to make the cake truffle, wherein the cake truffle has a water activity less than about 0.7 or ideally less than about 0.65, covering the cake truffle with a confectionary coating, or chocolate.

In one aspect, the method includes packaging the covered pieces to provide the shelf-stable food product.

The covered cake truffle product with the peanut butter layer on top of the cake truffle and between the cake truffle and the outer shell has a more desirable texture than commercial benchmark products.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 is a chart showing comparison of two month old Sample Nos. 1, 2, 3, 4, 5 and 6 from Table 5 with varying cake water activity, binding agents, outer shell/cake ratio, and pH for overall appeal, desirable flavor and desirable texture against a two week old commercially available comparative example.

FIG. 2 is an illustration of an embodiment of a confectionary food product of the present disclosure.

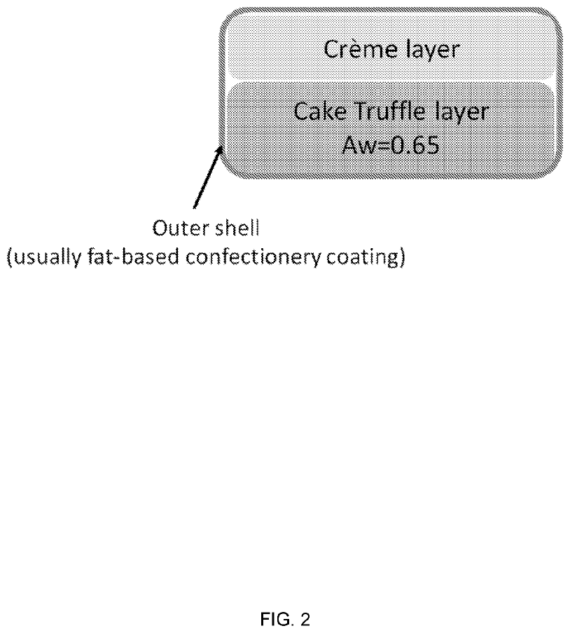

Unless otherwise stated, a reference to a compound or component includes the compound or component by itself, as well as in combination with other compounds or components, such as mixtures of compounds.

All publications, patents and patent applications cited herein, whether supra or infra, are hereby incorporated by reference in their entirety to the same extent as if each individual publication, patent or patent application was specifically and individually indicated to be incorporated by reference.

The following description provides additional specific embodiments. It is to be understood that still other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

The present disclosure provides confectionary food products and methods of making the same that are shelf-stable for at least 1 month at room temperature after packaging, in some embodiments at least 3 months, and in other embodiments at least 6 months, and in other embodiments up to 9 months. The product includes a cake formula and baking process to have a shelf-stable, especially micro-safe cake with water activity (Aw) less than 0.7, or ideally less than 0.65.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The present disclosure addresses the aforementioned need by providing a shelf-stable confectionary food product. The product includes a modified cake formula and baking process to have a shelf-stable, especially micro-safe cake with water activity (Aw) preferably less than 0.7 and, more preferably, less than 0.65.

The confectionary food product of the present disclosure includes a core composed of a baked cake formula ground into fine crumbs and blended with a binding agent to make a cake truffle. The cake formula comprises common cake ingredients, including but not limited to flour, egg white, shortenings, emulsifiers, etc., as well as agents to reduce water activity and help maintain moistness, texture and shelf life. Such agents include, but are not limited to, mono- and disaccharide sugars, glycerin (humectant), modified starch, and micro crystalline cellulose. Other ingredients such as sorbitol, allulose, and soluble corn fiber (e.g., Fibersol II®) may also be used as agents to reduce water activity and help maintain moistness, texture and shelf life.

A crème layer, is optionally provided which substantially covers the top layer of the core. The crème layer may be a water- or oil-based filling or crème, such as a peanut butter layer. Crème may be a sweet edible layer with oil or water as the continuous phase, where other particles like cocoa solids, sugar, milk solids, etc., are dissolved or dispersed in the continuous phase including chocolate crème, ganache and others.

In certain embodiments, sweetening agent(s) or combinations of sweetening agents are envisioned. Examples of suitable sweeteners include mono- and di-saccharide sugar, sucrose, fructose such as regular and high fructose corn syrup, dextrose, maltose, and reduced or zero calorie sweeteners such as sucralose and stevia extracts. In some embodiments, powdered sugar (sucrose) is used. In one embodiment, glycerine, mono- and di-saccharide sugar, modified starch, micro crystalline cellulose are used in the cake formula to reduce the water activity and help to maintain the moistness of the cake. The ratio of monosaccharide to di-saccharide sugar is typically from about 8:1 to about 1:1, in some embodiments from about 3:1 to about 2:1. In one embodiment, the modified starch is a modified wheat starch such as Fibersym®, a phosphated distarch phosphate wheat starch, or a modified rice starch such as RemyGel 663®, a fine cross-linked acetylated distarch phosphate. In another embodiment, the starch is a native corn starch.

Fine crumbs can be any previously baked crumb, such as crumbs from cake, brownies, cookies, sweet bread, or muffins. In most embodiments, crumbs are greater than 0.5 mm and typically no greater than about 3 mm. In some embodiments, crumbs do not have a single size, but have a distribution of sizes. In one embodiment, the ratio of baked cake crumbs to binding agent is from about 3:1 to about 10:1.

The binding agent of the present disclosure may be a syrup, a fat-based or an oil-based crème, or frosting.

As indicated above, binding agent may include ingredients in addition to the previous disclosure, ingredients such as flavorant(s), flavoring(s), humectant(s), emulsifier(s), acidulant(s), or antimicrobial(s). Examples of suitable flavorants or flavorings include spices and specific flavorings such as fruit, vanilla, butter, mint, chocolate, and the like. Examples of suitable antimicrobials or other preservatives or mold inhibitors include sodium salts of propionic or sorbic acids, potassium sorbate, sodium diacetate, vinegar, monocalcium phosphate, lactic acid, sodium benzoate, and mixtures thereof.

The confectionary food product of the present disclosure may optionally include an outer shell. The cake truffle can be sheeted and covered by a water- or oil-based crème layer which may be a filling or crème, such as a peanut butter layer. The cake truffle layer and the crème layer on top of the cake truffle layer may be substantially covered by the outer shell, i.e., surrounding the core and the crème layer. The outer shell may be chocolate or a fat-based confectionary coating. The fat-based confectionary coating may be a sweet edible layer with oil or fat as the continuous phase, where other particles like cocoa solids, sugar, milk solids, etc., are dispersed in the oil phase, such as chocolate. In one embodiment the outer shell is Reese's® milk chocolate.

Typically, the outer shell has a fairly even thickness. In this embodiment, both core and outer shell are approximately cuboidal. The confectionary food product of the present disclosure could be another shape, such as oval (egg shaped), cylindrical, cubic, spherical, pyramidal, conical, or an intricate shape such as an animal, object or other design. The confectionary food product of the present disclosure is often a single serving product, but could be multiple servings. Typically, the confectionary food product of the present disclosure has a size of about 1 oz. to about 3 oz.

In one embodiment, the shelf-stable cake truffle product may have three layers: a bottom cake truffle layer, a crème layer (either oil-based or water-based) on the cake truffle layer, and a milk chocolate or a confectionery coating layer, which is generally fat-based. Each of the core or cake truffle layer, the crème layer and the outer shell may be single or multiple layers.

Tables 1 and 2 provide an exemplary list of ingredients as well as exemplary formulation ranges for the ingredients in the product of the present disclosure.

TABLE 1
Shelf-stable Cake Truffle Formula

| | Percentage | | |
|---|---|---|---|
| | (%) by | Percentage | Amount |
| Components | weight | range (%) | (g) |
| Cake Truffle layer (Aw 0.69) | ~46% | | 916 |
| Chocolate Cake crumb, Aw = 0.7052 | ~32.5% | 13%-40% | 649 |
| Binding agent: | | | |
| Water | ~1.5% | 0%-3% | 27 |
| Chocolate Crème | ~6% | 0%-15% | 119 |
| Peanut butter crème | ~4% | 0%-8% | 77 |
| Peanut flavored crème | ~2% | 0%-4% | 41 |
| PB crème layer | ~24% | | 484 |
| Peanut butter crème | ~20.5% | 14%-24% | 411 |
| Peanut flavored crème | ~3.5% | 0%-10% | 72 |
| Outer shell Covering/Coating | — | | — |
| Milk chocolate | ~30% | 20%-30% | 599 |
| Total | 100% | | 2000 |

TABLE 2
Shelf-stable Cake Exemplary Formulation

| | | Percentage | |
|---|---|---|---|
| | | range | Amount |
| Ingredient | wet % | (%) | (g) |
| Flour: | | | |
| Soft wheat flour | ~15% | 12%-30% | 714 |
| Fats and oils: | | | |
| Cake shortening | ~21% | 15%-27% | 1007 |
| Sugars: | | | |
| Crystalline fructose | ~9% | 1%-28% | 480 |
| Anhydrous dextrose | ~4% | 1%-8% | 144 |
| Granulated sugar | ~5% | 0%-28% | 240 |
| Thickeners and texture modifiers: | | | |
| Resistant wheat starch | ~8.5% | 0%-15% | 408 |
| Powdered egg white | ~1.8% | 0%-5% | 83 |
| Pregelatinized waxy maize starch | ~2% | 0%-5% | 102 |
| Micro crystalline cellulose | ~0.8% | 0%-3% | 39 |
| Flavoring agent: | | | |
| Cocoa powder, alkalized | ~2.3% | 0.1%-5% | 109 |
| Vanilla flavor | ~0.3% | 0%-1% | 13 |
| Salt | ~0.3% | 0.1%-1% | 12 |
| Leavening agent: | | | |
| Baking Powder, aluminum free | ~0.9% | 0.1%-2% | 42 |
| Liquid: | | | |
| Water | ~22.2% | 15%-30% | 1073 |
| Glycerin | ~7% | 1%-12% | 326 |
| Total | 100% | | 4800 |

Tables 3 and 4 provide an exemplary list of ingredients as well as exemplary formulation ranges for the ingredients in the product of the present disclosure.

TABLE 3
Shelf-stable Cake Truffle Formula,
Total sample is about 600 grams (g)

| | Percentage |
|---|---|
| | (%) by |
| Components | weight |
| Cake Truffle layer (Aw 0.69) | ~47% |
| Chocolate Cake crumb, | ~33.4% |
| Aw = 0.6744 | |
| Binding agent: | |
| Corn syrup 62DE | ~4.0% |
| Invert syrup | ~0.6% |
| Glycerin | ~0.24% |
| Chocolate Crème | ~4.4% |
| Peanut butter crème | ~3.5% |
| Peanut flavored crème | ~0.9% |
| PB crème layer | ~23% |
| Peanut butter crème | ~17.3% |
| Peanut flavored crème | ~5.7% |
| Outer shell Covering/Coating | — |
| Milk chocolate | ~30% |
| Total | 100% |

TABLE 4A
Shelf-stable Cake Exemplary
Formulation, batch size 1600 grams

| Ingredient | wet % | Amount (g) |
|---|---|---|
| Flour: | | |
| Rice flour | 18.05% | 288.85 |
| Fats and oils: | | |
| Cake shortening | 20.84% | 333.49 |
| Sugars: | | |
| Crystalline fructose | 9.95% | 159.24 |
| Anhydrous dextrose | 2.97% | 47.52 |
| Granulated sugar | 3.96% | 63.38 |
| Thickeners and texture modifiers: | | |
| Corn fiber | 1.31% | 20.93 |
| Methyl cellulose | 0.81% | 12.97 |
| Pregelatinized waxy maize starch | 2.03% | 32.42 |
| Micro crystalline cellulose | 0.82% | 13.14 |
| Pre-gelatinized rice starch | 2.77% | 44.25 |
| Whey protein concentrate | 2.03% | 32.42 |
| Soy protein concentrate | 1.01% | 16.21 |
| Baking enzyme | 0.10% | 1.60 |
| Flavoring agent: | | |
| Cocoa powder, alkalized | 2.27% | 36.30 |
| Vanilla flavor | 0.28% | 4.54 |
| Salt | 0.27% | 4.27 |
| Leavening agent: | | |
| Baking Powder, aluminum free | 0.88% | 14.00 |
| Liquid: | | |
| Water | 22.90% | 366.46 |
| Glycerin | 6.75% | 108.02 |
| Total | 100% | 1600 |

TABLE 4B
Shelf-stable Vanilla Cake Exemplary
Formulation, batch size 1600 grams

| Ingredient | wet % |
|---|---|
| Flour: | |
| Soft wheat flour | ~14% |
| Fats and oils: | |
| Cake shortening | ~22% |
| Sugars and sweeteners: | |
| Corn syrup 62DE | ~20% |
| Baker's special sugar | ~4% |
| Thickeners and texture modifiers: | |
| Resistant wheat starch | ~9% |
| Powdered egg white | ~1.7% |
| Pregelatinized waxy maize starch | ~2% |
| Micro crystalline cellulose | ~0.8% |
| Flavoring agent: | |
| Vanilla flavor | ~0.2% |
| Salt | ~0.2% |
| Leavening agent: | |
| Baking Powder, aluminum free | ~1% |
| Liquid: | |
| Water | ~21.1% |
| Glycerin | ~4% |
| Total | 100% |

TABLE 4C
Shelf-stable Cake Exemplary Formulation of
gluten free and egg free cake made with native
corn starch, batch size 1600 grams

| Ingredient | wet % | Amount (g) |
|---|---|---|
| Flour: | | |
| Native corn starch | ~18% | 289 |
| Fats and oils: | | |
| Cake shortening | ~21% | 333 |
| Sugars: | | |
| Crystalline fructose | ~10% | 159 |
| Anhydrous dextrose | ~3% | 47 |
| Granulated sugar | ~3.9% | 63 |
| Thickeners and texture modifiers: | | |
| Corn fiber | ~1.3% | 21 |
| Methyl cellulose | ~0.8% | 13 |
| Pregelatinized waxy maize starch | ~2% | 32 |
| Micro crystalline cellulose | ~0.8% | 13 |
| Pre-gelatinized rice starch | ~2.7% | 44 |
| Whey protein concentrate | ~2% | 32 |
| Soy protein concentrate | ~1% | 16 |
| Baking enzyme | ~0.1% | 1.6 |
| Flavoring agent: | | |
| Cocoa powder, alkalized | ~2.3% | 36 |
| Vanilla flavor | ~0.3% | 5 |
| Salt | ~0.3% | 4 |
| Leavening agent: | | |
| Baking Powder, aluminum free | ~0.9% | 14 |
| Liquid: | | |
| Water | ~22.9% | 366 |
| Glycerin | ~6.8% | 108 |
| Total | 100% | 1600 |

TABLE 5
Shelf-stable Cake Truffle Formula of Table 2, Total sample is about 600 grams (g)

| | | | | binding | Crème % | | |
|---|---|---|---|---|---|---|---|
| Sample | Cake | | Crème/ | agent % in | in binding | | Cake layer |
| No. | Aw | Binding agent | Cake ratio | final product | agent | pH/preservative | Aw |
| 1 | 0.64 | Syrup | 0 | 9.3% | 0.0% | 7 | 0.63 |
| 2 | 0.64 | Crème | 0.37 | 11.9% | 100.0% | 7 | 0.66 |
| 3 | 0.64 | Crème + syrup | 0.19 | 12.8% | 48.8% | 7 | 0.6 |
| 4 | 0.64 | Crème + syrup | 0.26 | 14.0% | 60.5% | 7 | 0.6 |
| 5 | 0.78 | Frosting | — | 8.3% | 0.0% | 7 | 0.73 |
| 6 | 0.78 | Frosting | — | 8.7% | 0.0% | 5.7 (MicroGard) | 0.73 |

Two month old Sample Nos. 1, 2, 3, 4, 5 and 6 from Table 5 with varying cake water activity, binding agents, outer shell/cake ratio, and pH were compared for overall palatability, desirable flavor and desirable texture against a two week old commercially available comparative example.

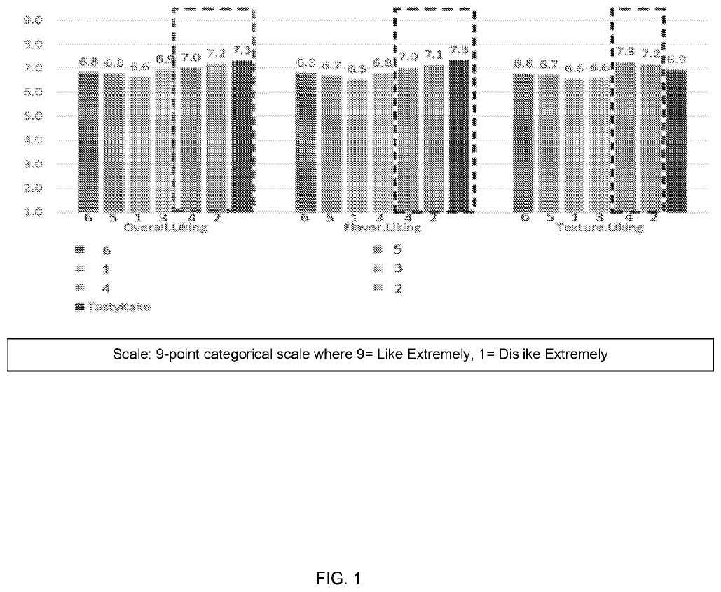

Product descriptions were presented before consumers tasted each sample. The data was analyzed using ANOVA with Tukey post-hoc test, α≥0.05. Samples with higher crème/cake ratio performed directionally better than other prototypes. The results are summarized in FIG. 1.

The baking process includes sheeting the cake batter to about 7 to about 13 mm sheet and baking at 325° F. for about 21 minutes to about 22 minutes with venting after 10 minutes of baking. The resulting baked cake has a water activity within the range of about 0.64 to about 0.71.

The baked cake is then ground into fine crumbs and blended with the binding agent to make cake truffle. The water activity of the cake truffle is about less than 0.7 or ideally about less than 0.65. The cake truffle has a distinguished moist texture according to sensory analysis. The cake truffle product with the peanut butter layer on top and covered with the outer shell comprising a fat-based confectionary coating has a more desirable texture than commercial benchmark products.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A shelf-stable, confectionary food product comprising,
a core formed from:
baked cake crumbs having a water activity from less than about 0.71, and
a binding agent.

2. (canceled)

3. (canceled)

4. The food product of claim 1, further including:
a crème layer, which substantially covers a top layer of the core, and
an outer shell surrounding the core and the crème layer, wherein the outer shell is a fat-based confectionery coating.

5. The food product of claim 4, wherein the crème layer is a water- or oil-based filling, crème, or frosting.

6. The food product of claim 5, wherein the crème layer is a peanut butter layer.

7. The food product of claim 4, wherein the fat-based confectionery coating is selected from the group consisting of milk chocolate, white chocolate, and dark chocolate.

8. The food product of claim 1, wherein the ratio of baked cake crumbs to binding agent is from about 3:1 to about 10:1.

9. The food product of claim 1, wherein the baked cake crumbs have a ratio of monosaccharide to disaccharide sugar from about 8:1 to about 1:1.

10. (canceled)

11. The food product of claim 1, wherein the binding agent is a syrup, a fat-based crème, or a mixture of both.

12. The food product of claim 1, wherein the binding agent includes crème.

13. The food product of claim 1, wherein the core includes a modified starch selected from the group consisting of a modified wheat starch, a modified rice starch, a modified potato starch, and a modified tapioca starch, or other hydrocolloids.

14. (canceled)

15. The food product of claim 13, wherein the modified starch comprises a phosphated distarch phosphate wheat starch or a fine cross-linked acetylated distarch phosphate.

16. The food product of claim 1, wherein the core includes a native corn starch.

17. (canceled)

18. A method of making a shelf-stable food product, the method comprising:
forming a cake truffle by:
sheeting a cake batter to about 7 mm to about 13 mm and baking to obtain a baked cake, wherein the baked cake has a water activity within the range of about 0.65 to about 0.71,
grinding the baked cake into fine crumbs,
blending the fine crumbs with a binding agent to make a cake truffle, wherein the cake truffle has a water activity less than about 0.7, and
covering the cake truffle with a confectionary coating or milk chocolate to form the shelf-stable food product.

19. (canceled)

20. The method of claim 18, further comprising a step of packaging the covered pieces to provide the shelf-stable food product.

21. The method of claim 18, wherein the fine crumbs have a ratio of monosaccharide to disaccharide sugar of from about 8:1 to about 1:1.

22. (canceled)

23. The method of claim 18, wherein the binding agent is a syrup or a fat-based crème.

24. The method of claim 18, wherein the binding agent includes crème.

25. The method of claim 18, wherein the cake truffle includes a modified wheat starch selected from a phosphated distarch phosphate wheat starch or a fine cross-linked acetylated distarch phosphate, or a modified rice starch.

26. (canceled)

27. (canceled)

28. The method of claim 18, wherein the cake truffle includes a native corn starch.

29. The method of claim 18, wherein baking is at 325° F. (163° C.) for about 21 minutes to about 22 minutes with venting after 10 minutes of baking.
